(19) United States
(12) Patent Application Publication
(10) Pub. No.: US 2002/0063899 A1
(43) Pub. Date: May 30, 2002

(54) Imaging device connected to processor-based system using high-bandwidth bus

(76) Inventors: Tinku Acharya, Chandler, AZ (US); Werner Metz, Chandler, AZ (US)

Correspondence Address: Timothy N. Trop, TROP, PRUNER & HU, P.C.,, STE 100, 8554 KATY FWY, HOUSTON, TX, 77024-1805, US

(21) Appl. No.: 09/726,773

(22) Filed: Nov. 29, 2000

(51) Int. Cl. H04N 1/21

(52) U.S. Cl. 358/302

(57) ABSTRACT

An imaging device is tethered to a processor-based system by a high-bandwidth serial bus. Image data produced in the imaging device is minimally processed before being transferred to the processor-based system for more extensive image processing. In particular, compression inside the imaging device may be avoided, for some image resolutions. Where higher throughput of image data through the high-bandwidth bus is desired, the imaging device performs scaled color interpolation on the image data before its transmission to the processor-based system.

### BACKGROUND

This invention relates to imaging devices and, more particularly, to an imaging device tethered to a processor-based system.

Digital cameras are a by-product of the personal computer (PC) revolution. Using electronic storage rather than film, digital cameras offer an alternative to traditional film cameras for capturing an image. Particularly where images are distributed by electronic mail or posted on web sites, digital cameras even supplant film cameras in some arenas.

Digital cameras may capture and store still images. Additionally, some digital cameras may store short movie clips, much like a camcorder does. Although no film is used in a digital camera, the electronically recorded image is nevertheless stored somewhere, whether on a non-volatile medium, such as a floppy or hard disk, a writable compact disc (CD), a writable digital video disk (DVD), or a flash memory device. These media vary substantially in their storage capabilities.

Many digital cameras typically interface to a processor-based system, both for downloading the image data and for further processing of the images. Digital cameras are often sold with software for such additional processing. Or, the digital cameras may produce image files that are compatible with commercially available image processing software.

The manner of downloading the image from the digital camera to the processor-based system depends, in part, on the storage medium. Digital cameras that store image data on 3½″ floppies may be the most intuitive for downloading the images. The floppy disk is removed from the camera and the image files stored thereon are simply transferred to storage on the processor-based system, just as any other file would be.

The storage capability of a 3½″ floppy disk, however, is quite limited. A single disk stores only five high-quality JPEG (Joint Photographic Experts Group) images or 16 medium-quality JPEG images.

Where flash memory is used to store images in the camera, a proprietary flash reader may be purchased and connected to the processor-based system for downloading the images. Or, the digital camera may be connected directly to a serial port of the processor-based system. At that point, the images may be downloaded from the digital camera's storage to the processor-based system's storage. While the serial port is slow, it is available on most processor-based systems.

A speedier solution may be to download the images using a Universal Serial Bus (USB). The Universal Serial Bus Specification Revision 2.0 (USB2), dated 2000, is available from the USB Implementer's Forum, Portland, Oreg. Increasingly, the USB interface is available on processor-based systems, and provides better throughput capability than the serial port. USB2, a higher-throughput implementation of the USB interface, offers even more capability than USB.

Thus, there is a continuing need to provide a an imaging device in which images may be downloaded to a processor-based system.

### BRIEF DESCRIPTION OF THE DRAWINGS

FIG. 1 is a block diagram of a system according to one embodiment of the invention;

FIG. 2 is a flow diagram of operations performed on image data by the camera according to one embodiment of the invention;

FIG. 3 is a diagram of a Bayer pattern according to one embodiment of the invention;

FIG. 4 is a diagram of a color interpolation algorithm employed by the camera according to one embodiment of the invention;

FIG. 5 is a diagram comparing different image resolutions, with and without scaled color interpolation, according to one embodiment of the invention; and

FIG. 6 is a video processing chain performed in the processor-based system according to one embodiment of the invention.

### DETAILED DESCRIPTION

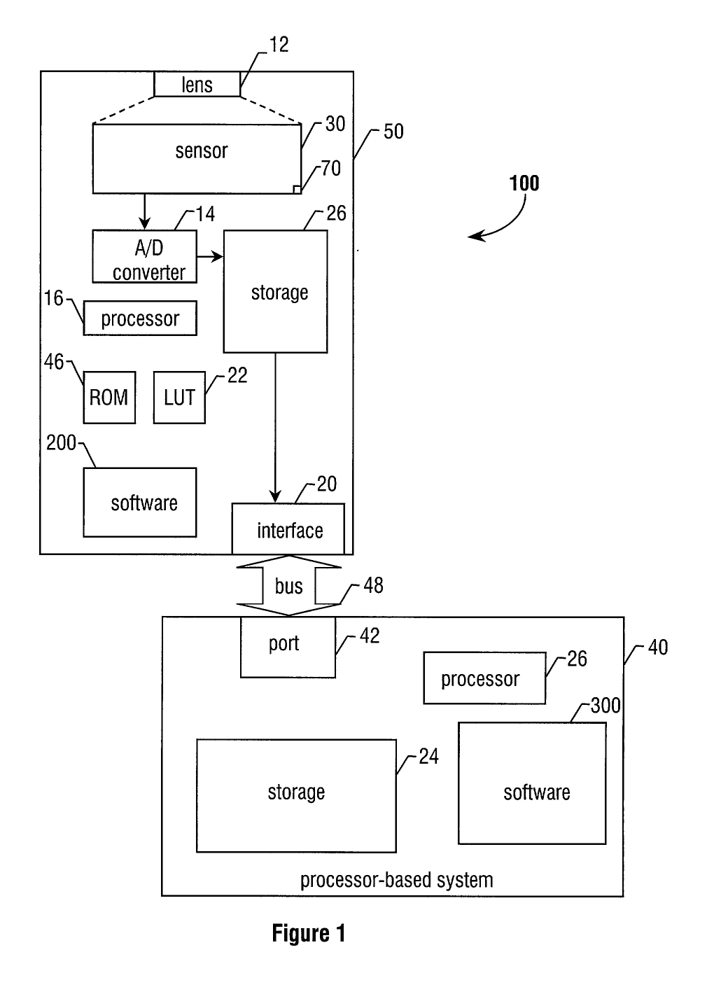

In FIG. 1, a system 100 includes an imaging device 50, such as a camera or scanner, connected to a processor-based system 40, such as a personal computer. The camera 50 includes a lens 12 for receiving incident light from a source image. The camera 50 also includes a sensor 30, for receiving the incident light through the lens 12.

The sensor 30 may be a charge-coupled device (CCD) or a Complementary Metal Oxide Semiconductor (CMOS) sensor, for capturing the image. The sensor 30 may include a matrix of pixels 70, each of which includes a light-sensitive diode, in one embodiment. The diodes, known as photosites, convert photons (light) into electrical charges. When an image is captured by the camera 50, each pixel 70 thus produces a voltage that may be measured.

In one embodiment, the sensor 30 is coupled to an analog-to-digital (A/D) converter 14. The A/D converter 14 converts the analog electrical charge in each photosite of the sensor 30 to digital values, suitable for storage. Accordingly, the camera 50 of FIG. 1 includes storage 26. The storage 26 may be volatile, such as a random access memory device, or non-volatile, such as disk media. In one embodiment, image data is stored in the storage 26 for a short time before being transferred to the processor-based system 40.

The camera 50 may itself be a processor-based system, including a processor 16. In one embodiment, the camera 50 performs a minimum amount of processing before sending the image data to the processor-based system 40. In one embodiment, the processing is performed by a software program 200. Although the software program 200 in the camera 50 may perform the operations described, below, discrete logic components, specialized on-chip firmware, and so on, may instead be implemented in the camera 50 for performing camera operations.

In one embodiment, the camera 50 is coupled to the processor-based system 40 by a high-bandwidth serial bus 48. In one embodiment, the bus 48 is a Universal Serial Bus 48. The Universal Serial Bus (USB) specification is a standardized peripheral connection that is substantially faster than the original serial port of a personal computer, supports plug and play, and supports multiple device connectivity. The Universal Serial Bus Specification Revision 1.1 (USB), dated Sep. 23, 1998, is available from the USB Implementer's Forum, Portland, Oreg. The USB specification supports data transfer rates of 1.5 Mbits/second and 12 Mbits/second. In one embodiment, the bus 48 receives data at a transfer rate higher than 12 Mbits/second.

In a second embodiment, however, the bus 48 supports a substantially higher data throughput than is available under USB. For example, under USB, revision 2, the USB port may support up to 480 Mbits/second throughput (best case at the peak data rate). The Universal Serial Bus Specification Revision 2.0 (USB2), dated Apr. 27, 2000, is also available from the USB Implementer's Forum, Portland, Oreg. The bus 48 is USB2-compliant, according to one embodiment.

Such a dramatic increase in data throughput offered by USB2 may be particularly beneficial for transmitting image data between the camera 50 and the processor-based system 40, in some embodiments. Although different image resolutions and transmission rates may be supported in digital cameras, both the amount of image data and rate of transmission is large in relation to other types of data transmitted serially.

In one embodiment, the bus 48 is a cable that connects between the entities 40 and 50 of the system 100. The camera 50 includes interface 20 while the processor-based system 40 includes port 42. In one embodiment, both the interface 20 and the port 42 support USB and USB2. With the bus 48 between the camera 50 and the processor-based system 40, substantial amounts of image data may be rapidly exchanged.

Typically, some of the active pixels in the sensor 30 are not perfect. Some of the pixels, for example, may be defective because of flaws during their manufacture. During manufacturing, the location of the defective pixels is identified and usually stored within the camera itself. Accordingly, the camera 50 of the system 100 includes a read-only memory (ROM) 46 in which the defective pixel information may be stored.

In one embodiment, the defective pixels are corrected by performing a linear combination of similar neighboring good pixels. Such an operation may be performed immediately after capturing the image. The operation is popularly known as the “dead pixel substitution.” In one embodiment, the software 200 of the camera 50 performs dead pixel substitution for each image captured by the sensor 30.

In one embodiment, the camera 50 also performs dark current subtraction. In the sensor 30, the values captured by the pixels 70 may not reflect the actual value of the energy that is measured by the incident light hitting the pixels 70 of the sensor 30. Instead, spurious dark currents are inherently introduced by transistors of the sensor 30 circuitry, due to changes in temperature during the image capture process. By performing dark current subtraction, an accurate reading of the image pixels may be restored. In one embodiment, the dark current values are identified and subtracted from the pixel values by the software 200.

In one embodiment, the camera 50 further performs quantization of the image data. Pixel data in the storage 26 may be quantized to some predetermined size. For example, if the individual pixels 70 are represented by more than 8 bits, the software 200 may quantize the pixel values to 8-bit values each.

In one embodiment, the software 200 quantizes the image data using a look-up table (LUT) 22, located in the camera 50. In a second embodiment, the software 200 performs a linearization operation of the values, based on some rendering criteria. Other quantization techniques may also be used.

The camera 50, according to one embodiment, further may perform contrast enhancement. Contrast enhancement may stretch the contrast of the images, such as where the pixels of the sensor 30 are not well-lit or are saturated with photons. In other words, where the intensity of all the photons of the sensor 30 are in either the low range or the high range of possible intensities, the software 200 may stretch these values such that they cover the entire range of possible intensities. Such stretching offers better quality in the captured image. As with quantization, contrast enhancement may be performed using the LUT table 22.

The system 100 thus includes a camera 50 tethered to the processor-based system 40 such that many imaging operations that would ordinarily be performed in the camera may be off-loaded to the more powerful processor-based system 40. As will be shown, such a configuration may be used in a relatively inexpensive camera architecture, according to one embodiment. However, compromises in image quality need not be expected, in some embodiments.

The aforementioned camera operations, dead pixel substitution, dark current subtraction, quantization, and contrast enhancement, are typically performed prior to compression and transmission of the image data. Accordingly, the operations are performed in the camera 50, such as by the software 200, in one embodiment.

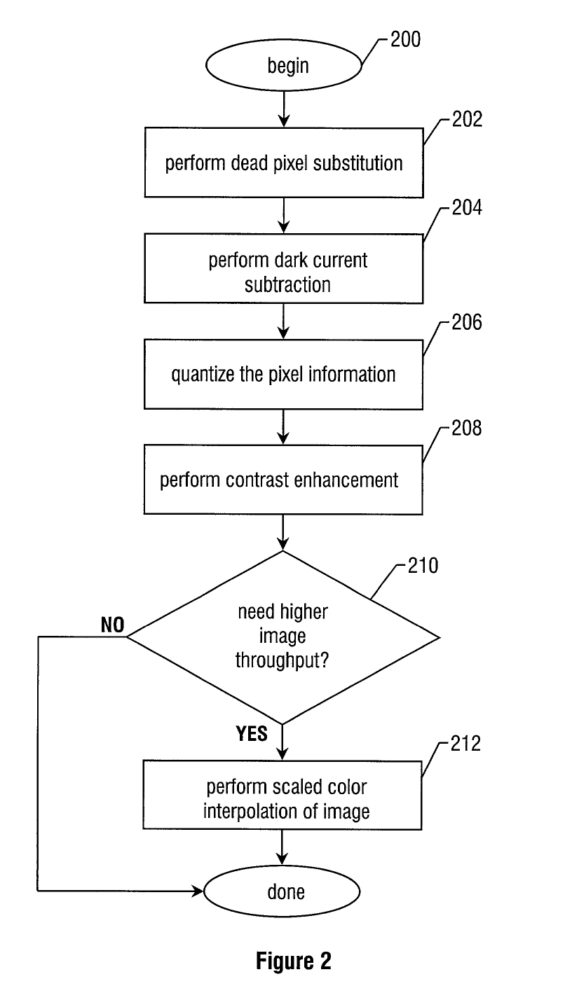

In FIG. 2, the software 200 performs the image operations for each image received by the sensor 30 of the camera 50. In one embodiment, the operations are performed on the image data stored in the storage 26. Although conducted by the software 200, one or more of the operations may instead be performed by hardware elements such as discrete logic components inside the camera 50.

Upon receiving the image data into the storage 26, the software 200 performs dead pixel substitution (block 202). In one embodiment, the software 200 retrieves dead pixel information from the ROM 46 and uses the information to perform the substitution operation. Because of the dark current inherently introduced by circuitry in the sensor 30, the software 200 also performs dark current subtraction (block 204), to subtract out the erroneous dark current data. The software 200 further may quantize the pixel information (block 206) as well as perform contrast enhancement (block 208).

In some embodiments, the camera 50 additionally performs color synthesis, also known as color interpolation or de-mosaicing, prior to sending the image data to the processor-based system 40. By performing color image synthesis in the camera 50, the image data size may be reduced. Accordingly, a higher throughput for transferring the data between the camera 50 and the processor-based system 40 may be achieved.

As explained above, the sensor 30 includes many pixels, each of which is a photosite to capture light intensity, which is then converted to electrical charges that can be measured. Color information may be extracted from the intensity data using color filters, in one embodiment. Typically, the color filters extract the three primary colors: red, green, and blue. From combinations of the three colors, the entire color spectrum, from black to white, may be derived. Other color schemes may be used.

Cameras employ different mechanisms for obtaining the three primary colors from the incoming photons of light. Very high quality cameras, for example, may employ three separate sensors, a first with a red filter, a second with a blue filter, and a third with a green filter. Such cameras typically have one or more beam splitters that send the light to the different color sensors. All sensor pixels receive intensity information simultaneously, and each pixel is dedicated to a single color. The additional hardware, however, makes these cameras relatively expensive.

A second method for recording the color information is to rotate a three-color filter across the sensor. Each sensor pixel may store all three colors. However, each color is stored at a different point in time. Thus, this method works well with still, but not candid or handheld photography, because the three colors are not obtained at precisely the same moment.

A third method for recording the three primary colors from a single image is to dedicate each sensor pixel to a different color value. In this manner, each of the red, green, and blue pixels are receiving image information simultaneously. The true color at each pixel may then be derived using color interpolation.

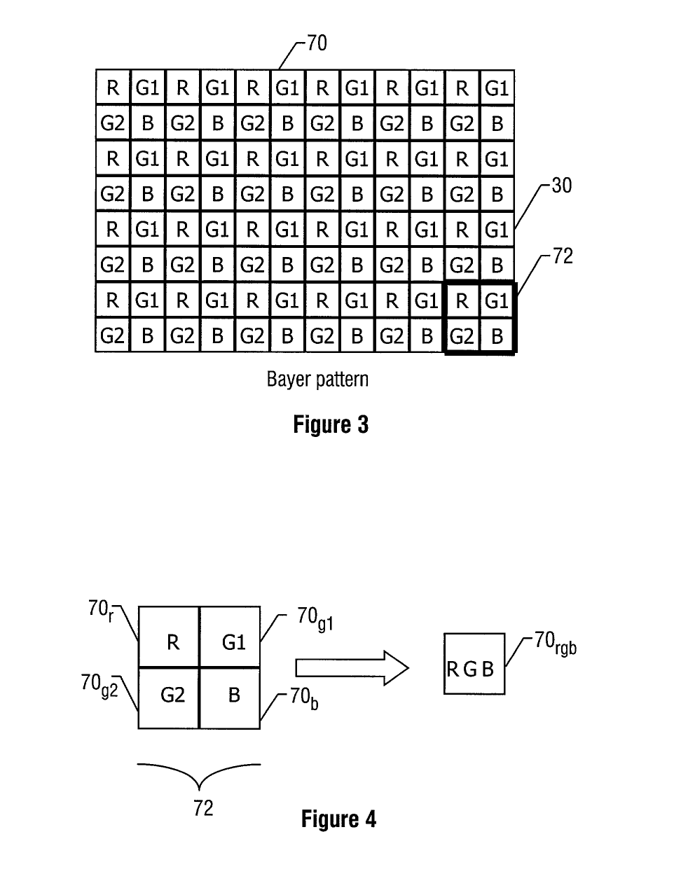

Color interpolation depends on the pattern, or “mosaic,” that describes the layout of the pixels 70 on the sensor 30. One common mosaic is known as a Bayer pattern. The Bayer pattern, shown in FIG. 3, alternates red and green pixels 70 in a first row of the sensor 30 with green and blue pixels 70 in a second row. As shown, there are twice as many green pixels 70 than either red or blue pixels. This is because the human eye is more sensitive to luminance in the green color region.

Bayer patterns are preferred for some color imaging because a single sensor is used, yet all the color information is recorded at the same moment. This allows for smaller, cheaper, and more versatile cameras.

Where the sensor 30 forms a Bayer pattern, a variety of color interpolation algorithms, both adaptive and non-adaptive, may be performed to synthesize the color pixels. Non-adaptive algorithms are performed in a fixed pattern for every pixel in a group. Such algorithms include nearest neighbor replication, bilinear interpolation, cubic convolution, and smooth hue transition.

Adaptive algorithms detect local spatial features in a group of pixels, then apply some function, or predictor, based on the features. Adaptive algorithms are usually more sophisticated than non-adaptive algorithms. Examples include edge sensing interpolation, pattern recognition, and pattern matching interpolation, to name a few.

In one embodiment, the camera 50 performs non-adaptive, scaled color interpolation on Bayer-patterned image data prior to sending the image data to the processor-based system 40. The scaled color interpolation may be performed by the software 200 or by discrete logic elements.

In the Bayer-patterned sensor 30 of FIG. 3, each 2×2 sub-block 72 includes a single red pixel, 70ᵣ, a single blue pixel, 70_{b}, and two green pixels, 70_{g1} and 70_{g2}. According to one embodiment, each 2×2 sub-block 72 of the sampled image is merged into a single, full-color pixel, 70_{rgb}, as shown in FIG. 4.

Although the sub-block 72 included four pixels, 70ᵣ, 70_{b}, 70_{g1}, and 70_{g2}, each pixel 70 is a single-byte, or single-color pixel. The full-color pixel, 70_{rgb}, however, is a three-color, or full-color pixel. The effect of the color interpolation operation, therefore, is to scale the image data by 25%. For some image data, a color interpolation scheme that scales the image data by 25% may preclude the performance of compression on the image data.

The ability to not compress the data allows a cheaper and simpler digital camera to be produced. Particularly where high-throughput transmission is available, such as by using a USB2-compliant bus, image data may be transmitted from the camera 50 to the processor-based system 40 without performing compression on the data, in some embodiments.

Using the color interpolation scheme of FIG. 4, the image data may instead be scaled, then quickly transmitted to the processor-based system 40, where compression may be performed, as desired. In the system 100, the processor-based system 40 includes substantially more computing power than the digital camera 50. By performing scaled color interpolation, more computationally intensive operations, such as compression, may be performed in the processor-based system, not the camera 50.

The full-color pixel, 70rgb, includes equal parts of red, blue, and green information. In one embodiment, the green information in the full-color pixel, 70rgb, is derived by averaging the two green pixels, 70_{g1} and 70_{g2}, of the 2×2 sub-block 72. In the full-color pixel, 70_{rgb}, the red information is unchanged from the pixel, 70ᵣ, and the blue information is unchanged from the pixel, 70_{b}.

Recall that, where the pixels 70 in the sensor 30 are larger than 8-bit, the camera 50 quantizes the values to an 8-bit value (see block 206 of FIG. 2). Thus, each monochrome pixel, 70ᵣ, 70_{b}, 70_{g1}, and 70_{g2}, of the sub-block 72 is represented by an 8-bit value. While the sub-block 72, as depicted in FIG. 3, is scaled down from a four-pixel sub-block 72 to a single pixel, 70_{rgb}, the single pixel is a three-byte, full-color pixel, not a monochrome pixel.

In this manner, an N×M sub-block 72 of monochrome pixels 70 is color interpolated into an N/2×M/2 sub-block of full-color pixels. In essence, this is a four-to-one scaling of the pixels 70, or a 75% reduction. However, since the pixel, 70_{rgb}, is a three-byte pixel, the information representing the image is reduced by 25%, not 75%.

The scaled color interpolation operation illustrated in FIG. 4 is particularly useful when a lower resolution image is to be constructed from a higher resolution image. As a result, the total data size for each frame of the captured image is reduced to 75% of the original size. Additional processing of the full color image may subsequently be performed in the processor-based system 40.

Thus, the camera 50 may effectively perform scaled color interpolation averaging the two green values, 70_{g1} and 70_{g2}. The minimal processing obviates the need for high-powered processors or math coprocessors within the camera 50. Further, discrete logic components may readily be implemented in the camera 50, for averaging the green data together.

In one embodiment, the scaled color interpolation algorithm is performed by the software 200, as depicted in FIG. 2. The software 200 determines whether higher image throughput is needed (diamond 210). If so, scaled color interpolation is performed in the camera 50 (block 212). Otherwise, the image data may be sent to the processor-based system 40, in the manner described in more detail, below.

In the system 100, the image data captured by the camera 50 is minimally processed therein, then transferred to the more powerful processor-based system for further processing. In one embodiment, as depicted in FIG. 1, this transfer takes place over the bus 48.

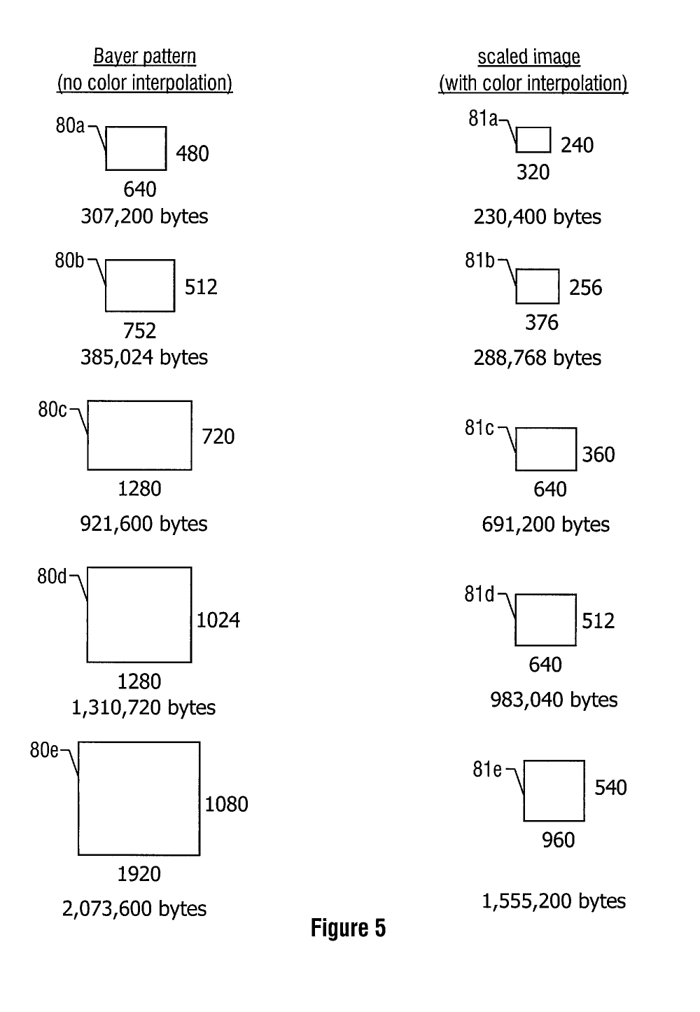

Under USB2, the bus 48 may operate in either asynchronous or isochronous modes. In isochronous mode, the bus 48 may support a 480 Mbit/second transfer rate. To understand how this data rate relates to typical image data, FIG. 5 includes a plurality of common frame resolutions and the number of bytes included in each frame 80. Using scaled color interpolation according to the embodiments described herein, the frames 80 are translated into scaled images 81.

Two sets of numbers are provided for each frame resolution. A first set of numbers corresponds to the number of bytes that may be transmitted through the bus 48 when no color interpolation is performed in the camera 50. A second set of numbers corresponds to the number of bytes that may be transmitted through the bus 48 when scaled color interpolation is performed, as described above and in FIG. 4.

Looking at the frame 80a, a 640×480 frame, 307,200 bytes are needed to describe each frame. With a 480 Mbit/second throughput (best case at the peak data rate) for USB2, the bus 48 may support about 195 frames/second at its limit. Put another way, at 60 frames/second, the frame 80a consumes 35% of the bandwidth of the bus 48 in isochronous mode. Since a video clip typically captures 60 frames/second at this resolution, the bus 48 would be able to transfer image data for the frame 80a readily without performing scaled color interpolation. Where scaled color interpolation is nevertheless performed, a scaled image 81a with a resolution of 320×240 results.

At maximum USB2 bandwidth, a 752×512 frame 80b, at a 60 /second frame rate, may successfully be received by the processor-based system 40. The USB2 bandwidth maximally supports about 156 of these frames/second, e.g., about 44% of bus 48 bandwidth. If scaled color interpolation is performed on the frame 80b, a 256×376 scaled image 81b, including 288,768 bytes, is produced. Note that the image 81b is one-fourth the size of the frame 80b, yet the number of bytes is reduced by 25%, not 75%.

At the higher resolutions, performing scaled color interpolation inside the camera 50 may be preferred. The 1280×720 frame 80c may be transmitted at 65 frames/second. Where a 60 frame/second video clip is produced in the camera 50, the bus 48 may be close to fully utilized, e.g., 86% of USB2 bandwidth. However, if scaled color interpolation is first performed on the frames 80c in the camera 50, the bus 48 will support 86 frames/second, more than enough for a 60 frame/second video clip.

The higher resolution frames 80d and 80e are good candidates for first performing scaled color interpolation in the camera 50. Without scaled color interpolation, the frame 80d may be transferred at a rate of about 45 frames/second while the frame 80e is transferred at fewer than 29 frames/second. With scaled color interpolation, frame 80d may be transferred over the bus 48 at a rate of 61 frames/second while frame 80e may be transferred at a rate of 38 frames/second.

Usually, the computational requirement of color interpolation is very high and even prohibitive for a very high-resolution video sequence captured at a very high frame rate. The scaled color interpolation performed by the camera 50 is possible, however, at these higher frame rates.

Although the scaled color interpolation is non-adaptive, the system 100 is flexible enough to allow other, more sophisticated color interpolation to be performed in the processor-based system 40. For image data where the throughput of the bus 48 is not at issue, such as for the frames 80a and 80b, color interpolation may thus be delayed.

Many prior art cameras perform compression on the image data before transmitting the data to a computer or other processor-based system. Many compression operations are lossy, meaning that, in decompressing a compressed image, some information is lost. Compression algorithms used with image data include JPEG and a wavelet transform-based algorithm, to name two examples.

The color interpolation feature of the camera 50 effectively compresses the image data (to 75% of the original size) without any associated loss of color information. The camera 50 may simply average the green values for each sub-block 72 without sophisticated and expensive circuitry. This, coupled with the high-bandwidth serial bus 48, allows the camera 50 to process medium- and high-resolution video clips without lossy compression.

Where more sophisticated color interpolation is desired, the operation may be off-loaded to the processor-based system 40. In addition to color interpolation, the processor-based system 40 may perform a variety of image processing operations, some of which are computationally intensive. These operations are known to those of skill in the art.

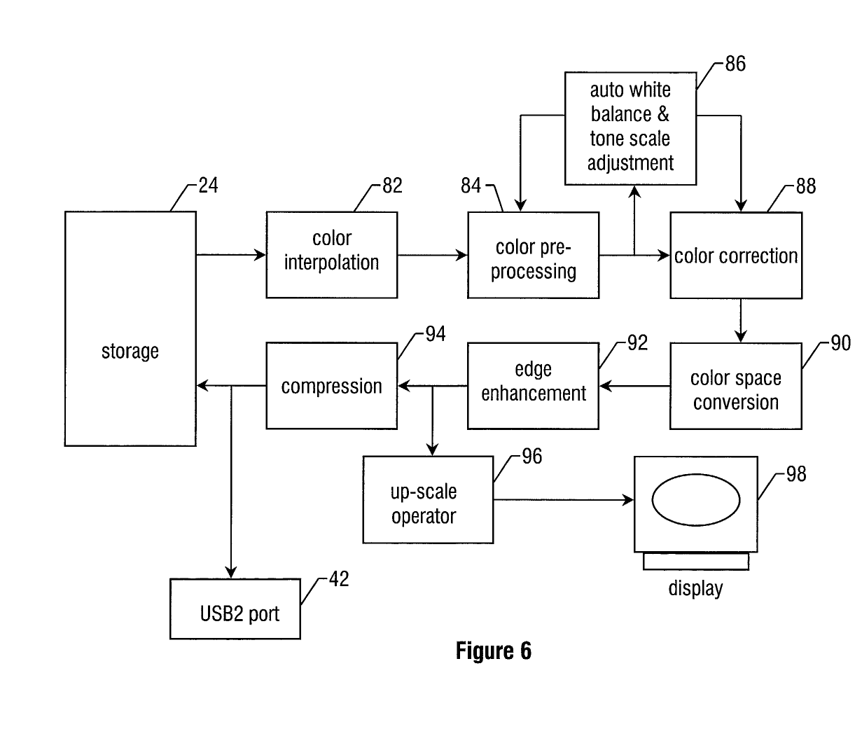

In FIG. 6, a video processing chain, performed in the processor-based system 40, according to one embodiment, begins by receiving the image data from the storage 24. The image data had been transferred from the camera 50, through the bus 48, to the storage 24.

In one embodiment, the video processing chain is performed by a software program 300, executed by a processor 26, as depicted in FIG. 1. Image data received from the camera 50 through the high-throughput bus 48 may be temporarily stored in a storage 24, before further processing of the image data takes place. In a second embodiment, a specialized digital signal processor (not shown) performs some portion of the operations described in the video processing chain of FIG. 6.

Where scaled color interpolation was not performed in the camera 50, as described above, the operation may now be performed in the processor-based system 40, according to one embodiment. Accordingly, the video processing chain of FIG. 6 includes color interpolation 82, to be performed on the retrieved image data.

Following the color interpolation 82, one or more color pre-processing operations 84 may be performed, in one embodiment. The color pre-processing operations 84 may include color space conversion, initial white balancing, color gamut correction, to name a few examples.

The video processing chain further includes color correction 86. Color correction is performed to ensure an objective interpretation of the color information. Each physical device senses color in a device-specific manner. For example, how the sensor 30 interprets color information depends on the color of the filters forming the Bayer pattern of the sensor 30. Accordingly, a translation between the device color space and an objective color space (usually called device-independent color space) is made.

To correctly interpret the color information in the measurements of different color devices, the spectral response characteristics of the devices are typically obtained. However, here, the color correction is being performed in the processor-based system 40, rather than in the camera 50 itself. Thus, according to one embodiment, device-independent color management is performed.

In one embodiment, the relationship between the measurement space of each device and a common standard color space, such as 1931CIE XYZ (2° observer) color, is determined. Such relation is typically specified by a linear/nonlinear transformation or a multi-dimensional LUT, established through minimizing some error measure between the target and the transformed color coordinates in the standard color space over a large set of color patches. Once the relation determined, the image data may be “color corrected” to account for the differences.

An auto white balance and tone scale adjustment operation 86 is also performed in the video processing chain of FIG. 6, according to one embodiment. In this operation, the white point of the image is restored to match the human perception under the capture illuminate. In one embodiment, the white point is estimated from the captured image and the measured signal in each color channel is scaled according to the estimated white point.

The tone scale of the captured image may then be modified and gamma corrected, to suppress stray light or viewing flare effect, enhance the skin-tone, and to match the display gamma characteristic. The auto white balance and tone scale adjustment 86 may be performed before or after the color correction operation 88, according to one embodiment.

The video processing chain of FIG. 6 also includes a color space conversion operation 90. Following the color correction operation 88, the image color may further be converted to a color space (such as YCbCr) that is more suitable for certain image processing operations, such as edge enhancement and image compression. (Where no edge enhancement or compression is to be performed, the color space conversion 90 may be skipped, as desired.) Color space conversion 90 may be done through a 3×3 matrix multiplication on each color pixel.

Due to the high frequency response limitation in many image sensors and other optical elements, images captured by a digital camera are typically not as sharp as desired. In addition, some image processing functions, such as color interpolation, compression, and noise reduction, may further reduce the sharpness of the captured images. An edge enhancement operation 92, according to one embodiment, includes sharpening processes, such as for removing blurring artifacts. In one embodiment, the edge enhancement 92 applies a convolution of a sharpening kernel with the captured image.

The video processing chain further includes compression 94. In one embodiment, the compression operation 94 compresses the data to obviate transmission bandwidth or storage limitations, due to the size and frequency of the image data.

As described above, a variety of compression algorithms are used with video data. Often, a standard compression technique is applied in the processor-based system 40 so that the data may be transmitted through standard communication medium, such as the port 42. At the receiving end, the image data may be decompressed.

In one embodiment, the video processing chain of FIG. 6 further includes an up-scale operator 96. Up-scaling may be performed where the image was 2:1 down-scaled in the camera 50 during scaled color interpolation. Where color interpolation 82 was instead performed in the processor-based system 40, no up-scaling may be necessary. In one embodiment, the up-scale operator 96 performs simple bi-linear interpolation to restore the original image resolution.

In one embodiment, up-scaled image data is sent to a display 98 for viewing. In a second embodiment, the image data is returned to the storage 24, following image processing. In a third embodiment, the image data is compressed, then sent to another entity. The data may be transmitted over the high-throughput port 42, over a network, over a serial port, and so on.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
producing image data in an imaging device coupled to a processor-based system by a serial bus comprising a bandwidth of at least twelve million bits each second;
performing operations on the image data in the imaging device, wherein the operations do not include compression of the image data; and
transferring the image data to the processor-based system through the serial bus.

2. The method of claim 1, performing operations on the image data in the imaging device further comprising:
performing dead pixel substitution on the image data.

3. The method of claim 1, performing operations on the image data in the imaging device further comprising:
performing dark current subtraction on the image data.

4. The method of claim 1, performing operations on the image data in the imaging device further comprising:
quantizing the image data.

5. The method of claim 1, performing operations on the image data in the imaging device further comprising:
performing contrast enhancement on the image data.

6. The method of claim 1, performing operations on the image data in the imaging device further comprising:
performing scaled color interpolation on the image data.

7. The method of claim 6, performing scaled color interpolation on the image data further comprising:
identifying a sub-block of a Bayer patterned sensor in the imaging device;
extracting a pair of green components from the sub-block; and
averaging the pair of green components to produce a new green component.

8. The method of claim 7, further comprising:
extracting a red component from the sub-block;
extracting a blue component from the sub-block; and
producing a true-color pixel comprising the red component, the blue component, and the new green component.

9. The method of claim 1, further comprising:
performing operations on the image data in the processor-based system.

10. The method of claim 9, performing operations on the image data in the processor-based system further comprising performing color interpolation on the image data.

11. The method of claim 9, performing operations on the image data in the processor-based system further comprising performing color space conversion on the image data.

12. The method of claim 9, performing operations on the image data in the processor-based system further comprising performing automatic white balance and tone scale adjustment on the image data.

13. The method of claim 9, performing operations on the image data in the processor-based system further comprising performing compression on the image data.

14. The method of claim 1, transferring the image data to the processor-based system through the serial bus further comprising transmitting the image data over a bus that is compliant with a universal serial bus, revision 2, specification.

15. The method of claim 1, transferring the image data to the processor-based system through the serial bus further comprising transmitting the image data to the processor-based system at a rate higher than twelve million bits per second.

16. An imaging device comprising:
a sensor to receive incident light and produce image data; and
an interface to connect the imaging device to a processor-based system, wherein the imaging device sends uncompressed image data to the processor-based system using a serial bus comprising a bandwidth that exceeds twelve million bits each second.

17. The imaging device of claim 16, wherein the interface is compliant with a Universal Serial Bus, Revision 2, specification.

18. The imaging device of claim 16, further comprising:
a software program to operate on the uncompressed image data.

19. The imaging device of claim 18, further comprising a read-only memory wherein the software program performs dead pixel substitution on the uncompressed image data using the read-only memory.

20. The imaging device of claim 19, wherein the software program performs dark current subtraction on the uncompressed image data using the read-only memory.

21. The imaging device of claim 20, further comprising a look-up table, wherein the software program uses the look-up table to quantize the uncompressed image data.

22. The imaging device of claim 21, wherein the software program performs contrast enhancement on the uncompressed image data using the look-up table.

23. The imaging device of claim 18, wherein the image data is Bayer-patterned and the software program performs color interpolation on the uncompressed image data by:
identifying a sub-block of the uncompressed image data;
averaging a pair of green components in the sub-block to produce a new green component; and
producing a true-color pixel.

24. The imaging device of claim 23, wherein the true-color pixel comprises:
a red component from the sub-block;
a blue component from the sub-block; and
the new green component.

25. An article comprising a medium for storing a software program to enable a processor-based system to:
produce image data;
perform operations on the image data, wherein the operations do not include compression; and
transfer the image data to a second processor-based system through a serial bus comprising a throughput of not less than twelve million bits each second.

26. The article of claim 25, further storing the software program to enable the processor-based system to further:
optionally perform color interpolation in the processor-based system or in the second processor-based system.

27. The article of claim 25, further storing the software program to enable the processor-based system to further:
perform dead pixel substitution in the processor-based system.

28. The article of claim 25, further storing the software program to enable the processor-based system to further:
perform dark current subtraction in the processor-based system.

29. The article of claim 25, further storing the software program to enable the processor-based system to further:
quantize the image data in the processor-based system.

30. The article of claim 25, further storing the software program to enable the processor-based system to further:
perform contrast enhancement in the processor-based system.

31. The article of claim 26, further storing the software program to enable the processor-based system to perform color interpolation by:
identifying a sub-block of Bayer-patterned image data;
averaging a pair of green components in the sub-block to produce a new green component; and
combining the new green component with a red component from the sub-block and a blue component from the sub-block to produce a true-color pixel.

32. The article of claim 26, further storing the software program to enable the processor-based system to transfer the image data to a second processor-based system using a Universal Serial Bus, Revision 2, specification-compliant bus.
